(19) United States
(12) Patent Application Publication
(10) Pub. No.: US 2011/0008544 A1
(43) Pub. Date: Jan. 13, 2011

(54) METHOD OF MANUFACTURING ENDLESS BELT MEMBER, ENDLESS BELT MEMBER, AND IMAGE FORMING APPARATUS

(75) Inventors: Yuichi YASHIKI, Kanagawa (JP); Daisuke TANEMURA, Kanagawa (JP); Shuhei YAMAZAKI, Kanagawa (JP); Tomoki FUSE, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/694,698

(22) Filed: Jan. 27, 2010

(30) Foreign Application Priority Data
Jul. 8, 2009 (JP) 2009-162153

(51) Int. Cl. B05D 3/04; G03G 15/01

(52) U.S. Cl. 427/378; 399/302

(57) ABSTRACT

A method of manufacturing an endless belt member is provided, the method including: applying a film forming resin solution onto a surface of a cylindrical core body; drying the film forming resin solution applied on the core body while rotating the core body around an axial direction of the core body; providing a shielding member to one end side of the core body in the axial direction, the shielding member shielding a wind fed from the one end side; and manufacturing an endless belt member on which the film forming resin is solidified, by putting the core body to which the shielding member is provided into a heating furnace equipped with a blowing part that blows a hot air from the one end side, and heating the core body.

### CROSS-REFERENCE TO RELATED APPLICATIONS

This application is based on and claims priority under 35 U.S.C. 119 from Japanese Patent Application No. 2009-162153 filed Jul. 8, 2009.

### BACKGROUND

1. Technical Field

The present invention relates to a method of manufacturing an endless belt member, an endless belt member, and an image forming apparatus.

2. Related Art

In the prior art, in the image forming apparatuses such as the copying machine, the printer, and the like, the endless belt member made of resin, i.e., the so-called endless belt, is employed widely, as the intermediate transferring member on which the visual image formed on the surface of the image holding body is transferred temporarily before the image is transferred on the medium and the medium carrying member which carries the medium while holding the image on its surface.

### SUMMARY

According to an aspect of the present invention, there is provided a method of manufacturing an endless belt member, the method including at least:

applying a film forming resin solution onto a surface of a cylindrical core body;

drying the film forming resin solution applied on the core body while rotating the core body around an axial direction of the core body;

providing a shielding member to one end side of the core body in the axial direction, the shielding member shielding a wind fed from the one end side; and

manufacturing an endless belt member on which the film forming resin is solidified, by putting the core body to which the shielding member is provided into a heating furnace equipped with a blowing part that blows a hot air from the one end side, and heating the core body.

### BRIEF DESCRIPTION OF THE DRAWINGS

Exemplary embodiments of the present invention will be described in detail based on the following figures, wherein:

FIG. 1 is an overall explanatory view of an image forming apparatus of Exemplary Embodiment 1 of the present invention;

FIG. 2 is a pertinent explanatory view of Exemplary Embodiment 1 of the present invention;

FIG. 3 is an overall explanatory view of a cylindrical core body of Exemplary Embodiment 1;

FIG. 4 is an explanatory view of a method of applying a film forming resin solution in Exemplary Embodiment 1 on an outer surface;

FIGS. 5A and 5B are pertinent enlarged explanatory views of a core body end portion, wherein FIG. 5A is an explanatory view of a state that the film forming resin solution is applied, and FIG. 5B is an explanatory view of a state that a masking member is released;

FIG. 6 is an explanatory view of a shielding member in Exemplary Embodiment 1;

FIG. 7 is an explanatory view of a shielding member in Variation 1;

FIG. 8 is an explanatory view of a shielding member in Variation 2;

FIG. 9 is an explanatory view of a shielding member in Variation 3;

FIG. 10 is an explanatory view of a shielding member in Variation 4;

FIG. 11 is an explanatory view of a shielding member in Variation 5;

FIGS. 12A and 12B are explanatory views of experimental results in Experimental Example 1 and Comparative Example 1, wherein FIG. 12A is a graph in which a height of a core body in the axial direction is plotted on an abscissa and a reached temperature is plotted on an ordinate, and FIG. 12B is a graph in which a height of a core body in the axial direction is plotted on an abscissa and a surface resistivity is plotted on an ordinate;

FIGS. 13A and 13B are explanatory views of experimental results in Experimental Examples 1 to 3 and Comparative Example 1, wherein FIG. 13A is a graph in which a height of a core body in the axial direction is plotted on an abscissa and a reached temperature is plotted on an ordinate, and FIG. 13B is a graph in which a height of a core body in the axial direction is plotted on an abscissa and a surface resistivity is plotted on an ordinate; and

FIGS. 14A and 14B are explanatory views of experimental results in Experimental Examples 1, 4, 5 and Comparative Example 1, wherein FIG. 14A is a graph in which a height of a core body in the axial direction is plotted on an abscissa and a reached temperature is plotted on an ordinate, and FIG. 14B is a graph in which a height of a core body in the axial direction is plotted on an abscissa and a surface resistivity is plotted on an ordinate.

### DETAILED DESCRIPTION

Next, concrete examples of the embodiment of the present invention (referred to as “Exemplary Embodiments” hereinafter) will be explained with reference to the drawings hereinafter. But the present invention is not limited to following Exemplary Embodiments.

Here, in order to facilitate the understanding of subsequent explanations, in the drawings, it is assumed that the front-back direction is set as the X-axis direction, the lateral direction is set as the Y-axis direction, and the vertical direction is set as the Z-axis direction, and that directions or sides indicated by arrows X, −X, Y, −Y, Z, −Z, denote forward, backward, rightward, leftward, upward, downward, or front side, rear side, right side, left side, upper side, lower side respectively.

Also, in the drawings, it is assumed that a mark depicted by putting “” in “O” denotes an arrow that is directed from the back of a sheet to the front and a mark depicted by putting “x” in “O” denotes an arrow that is directed from the front of the sheet to the back.

Also, in the explanation made hereunder by reference to the drawings, for the easy understanding, the illustration of the members other than those necessary for the explanation is appropriately omitted hereinafter.

### Exemplary Embodiment 1

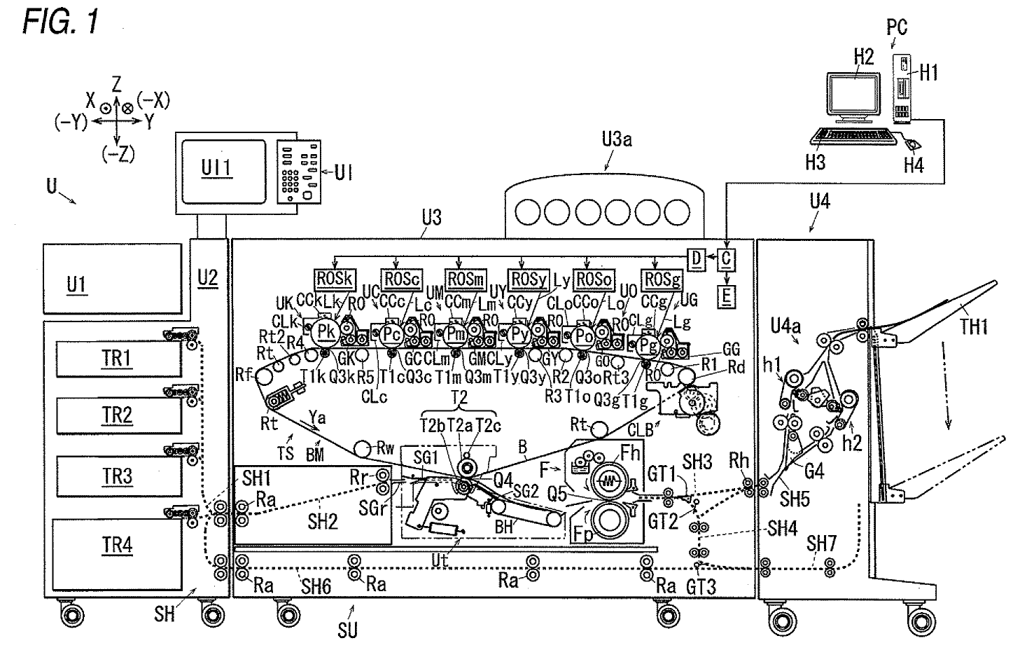

FIG. 1 is an overall explanatory view of an image forming apparatus of Exemplary Embodiment 1 of the present invention.

In FIG. 1, an image forming apparatus U of Exemplary Embodiment 1 includes a user interface UI as an example of the operating portion, an image inputting device U1 as an example of the image information inputting device, a paper feeding device U2, an image forming apparatus main body U3, and a paper processing device U4.

The user interface UI is equipped with input buttons such as a copy start key as an example of the operation start button, a copied-sheet count setting button as an example of the sheet count setting button, a ten-key pad as an example of the numeral inputting button, etc., and a display UI1.

The image inputting device U1 is constructed by the image scanner as an example of the image reading device, or the like. In FIG. 1, the image inputting device U1 reads an original (not shown) and converts the image into image information, and inputs the image information into the image forming apparatus main body U3.

Also, in Exemplary Embodiment 1, a client personal computer PC as an example of the image information transmitting device is connected to the image forming apparatus main body U3. The image information are input into the image forming apparatus main body U3 from the client personal computer PC.

In Exemplary Embodiment 1, the client personal computer PC is constructed by the calculator, i.e., the computer device. The client personal computer PC is constructed by a computer main body H1 as an example of the image information transmitting device main body, a display H2 as an example of the display member, a keyboard H3, a mouse H4, or the like as an example of the inputting member, an HD drive, i.e., a hard disc drive as an example of the information storing member (not shown), and the like.

The paper feeding device U2 has paper feed trays TR1 to TR4 as an example of a plurality of paper feeding portions. Recording sheets S as an example of the final transferring member or the medium are contained in the paper feed trays TR1 to TR4. The recording sheets S picked up from the paper feed tray TR1 to TR4 are carried to the image forming apparatus main body U3 through a paper feed path SH1.

In FIG. 1, the image forming apparatus main body U3 includes an image recording portion for making the image recording on the recording sheets S fed from the paper feeding device U2, a toner dispenser unit U3a as an example of the developer supply unit, a paper carry path SH2, a paper exhaust path SH3, a paper reverse path SH4, a paper circulate path SH6, and the like.

Also, the image forming apparatus main body U3 includes a control portion C, a laser driving circuit D as an example of the latent image writing apparatus driving circuit controlled by the control portion C, a power supply circuit E controlled by the control portion C, and the like. The laser driving circuit D outputs laser driving signals, which respond to the image information in green (G), i.e., green color, orange (O), i.e., orange color, yellow (Y), i.e., yellow color, magenta (M), i.e., reddish purple color, cyan (C), i.e., indigo blue color, and black (K), i.e., black color all being input from the image inputting device U1, to latent image forming devices ROSg, ROSo, ROSy, ROSm, ROSc, ROSk in respective colors at previously set times, i.e., predetermined timings.

Respective color image holding units UG, UO, UY, UM, UC, UK and respective color developing units GG, GO, GY, GM, GC, GK as an example of the developing device respectively are supported under the latent image forming devices ROSg to ROSk. Respective image holding units UG to UK and respective developing units GG to GK are detachably fitted to the image forming apparatus main body U3.

The black image holding unit UK has a photosensitive drum Pk as an example of the image holding body, a charger CCk, and a cleaner CIA as an example of the image holding body cleaner. Also, a developing roller R0 as an example of the developing member of the black developing unit GK is adjacent to the right side of the photosensitive drum Pk. Also, photosensitive drums Pg, Po, Py, Pm, Pc as an example of the image holding body respectively, chargers CCg, CCo, CCy, CCm, Cco, and cleaners CLg, CLo, CLy, CLm, CLo are similarly adjacent in other image holding unit UG to UC. Also, the developing rollers R0 of respective color developing units GG to GC are adjacent to the right side of the photosensitive drums Pg to Pc.

In Exemplary Embodiment 1, the photosensitive drum Pk for K color, whose frequency of use is high and whose surface wear is heavy, is constructed to have a larger diameter than other color photosensitive drums Pg to Pc. Therefore, the higher-speed revolution and the longer life are ensured.

Also, visible image forming apparatuses (UG+GG), (UI+GO), (UY+GY), (UM+GM), (UC+GC), (UK+GK) are constructed by the image holding units UY to UO and the developing units GY to GO respectively.

In FIG. 1, the photosensitive drums Pg to Pk are charged uniformly by the chargers CCg to CCk respectively. Then, the electrostatic latent image is formed on the surfaces of the photosensitive drums by laser beams Lg, Lo, Ly, Lm, Lc, Lk as an example of the latent image writing light being output from the latent image forming devices ROSg to ROSk respectively. Then, the electrostatic latent images formed on the surfaces of the photosensitive drums Pg to Pk are developed into toner images as an example of visible images in green (G), orange (O), yellow (Y), magenta (M), cyan (C), and black (K) colors by the developing units GG to GK respectively.

The toner images on the surfaces of the photosensitive drums Pg to Pk are transferred sequentially superposedly onto an intermediate transfer belt B, which is an example of the endless belt member and an example of the intermediate transferring member, by primary transfer rollers T1g, T1o, T1y, T1m, T1c, T1k as an example of the primary transfer devices in primary transfer areas Q3g, Q3o, Q3y, Q3m, Q3c, Q3k as an example of the intermediate transfer areas being set in the lower portion. The toner images transferred on the intermediate transfer belt B are carried to a secondary transfer area Q4.

In this case, when black image data are required, only the black-color photosensitive drum Pk and the developing unit GK are used, and only the black toner image is formed.

After the primary transfer, the residual toners on the surfaces of the photosensitive drums Pg to Pk are cleaned by the cleaners CLg to CLk for the photosensitive drums.

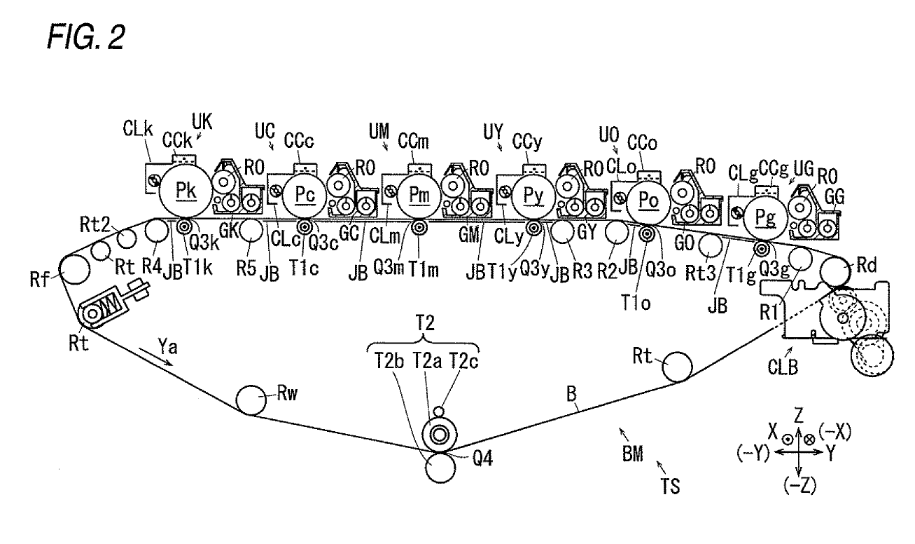

FIG. 2 is a pertinent explanatory view of Exemplary Embodiment 1 of the present invention.

Also, in FIG. 1 and FIG. 2, a belt module BM as an example of the intermediate transfer device is supported under the visible image forming apparatuses (UG+GG) to (UK+GK).

The belt module BM contains the intermediate transfer belt B. A belt driving roller Rd as an example of the intermediate transfer driving member is arranged to the right end portion on the back surface side of the intermediate transfer belt B. The belt driving roller Rd is rotated/driven in an arrow Ya direction as the rotating direction of the intermediate transfer belt B. Also, support rollers Rt2, Rt3 as an example of the supporting members, which support rotatably the intermediate transfer belt B, are arranged on the left side of the black-color photosensitive drum Pk and between the photosensitive drums Pg, Pc. Also, a plurality of tension rollers Rt as an example of the tension applying members, which apply a tensile force to the intermediate transfer belt B, are arranged on the back surface side of the intermediate transfer belt B. Further, a walking roller Rw as an example of the zigzag preventing member that prevents the zigzag movement of the intermediate transfer belt B, a plurality of idler rollers Rf as an example of the idler members, and a backup roller T2a as an example of the secondary transfer opposing member are arranged on the back surface side of the intermediate transfer belt B.

Therefore, in the belt module BM in Exemplary Embodiment 1, the intermediate transfer belt B is spread by respective rollers Rd, Rt2, Rt3, Rt, Rw, Rf, T2a, etc.

Also, in Exemplary Embodiment 1, a first retract roller R1 as an example of the first contact/release member, which is supported movably in the contact/release direction that is perpendicular to the arrow Ya direction, is arranged on the upstream side in the arrow Ya direction of the G—color primary transfer device T1g. The first retract roller R1 in Exemplary Embodiment 1 is supported movably between a first contact position, in which the intermediate transfer belt B is brought into contact with the green-color photosensitive drum Pg, and a first release position, in which the intermediate transfer belt B is released from this photosensitive drum Pg.

Also, a second retract roller R2 as an example of the second contact/release member, which is constructed similarly to the first retract roller R1, and a third retract roller R3 as an example of the third contact/release member are arranged in parallel between the primary transfer rollers T1o, T1y. The second retract roller R2 in Exemplary Embodiment 1 is supported movably between a second contact position, in which the intermediate transfer belt B is brought into contact with the orange-color photosensitive drum Po, and a second release position, in which the intermediate transfer belt B is released from this photosensitive drum Po. Also, the third retract roller R3 in Exemplary Embodiment 1 is supported movably between a third contact position, in which the intermediate transfer belt B is brought simultaneously into contact with the Y, M, C photosensitive drums Py to Pc, and a third release position, in which the intermediate transfer belt B is released simultaneously from these photosensitive drums Py to Pc.

Also, a fourth retract roller R4 as an example of the fourth contact/release member, which is constructed similarly to the retract rollers R1 to R3, is arranged on the downstream side of the K-color primary transfer device T1k in the arrow Ya direction. The fourth retract roller R4 in Exemplary Embodiment 1 is supported movably between a fourth contact position, in which the intermediate transfer belt B is brought into contact with the black-color photosensitive drum Pk, and a fourth release position, in which the intermediate transfer belt B is released from this photosensitive drum Pk.

Further, a fifth retract roller R5 as an example of the fifth contact/release member, which is constructed similarly to the retract rollers R1 to R4, is arranged between the primary transfer rollers T1c, T1k. The fifth retract roller R5 in Exemplary Embodiment 1 is supported movably between a fifth contact position, in which the intermediate transfer belt B is brought into contact with either or both of the Y, M, C photosensitive drums Py to Pc and the black-color photosensitive drum Pk, and a fifth release position, in which the intermediate transfer belt B is released from these photosensitive drums Py to Pk.

Also, a static electricity eliminating plate JB as an example of the static electricity eliminating member, which eliminates the charge from the back surface of the intermediate transfer belt B, is arranged on the downstream side of the primary transfer rollers T1g to T1k in the arrow Ya direction. In this case, the static electricity eliminating plate JB in Exemplary Embodiment 1 is arranged not to touch the intermediate transfer belt B, e.g., may be arranged in a position that is distant from the back surface of the intermediate transfer belt B by 2 mm.

The belt supporting rollers Rd, Rt, Rw, Rf, T2a, R1 to R5 as an example of the intermediate transferring member supporting member, which supports rotatably from the back surface of the intermediate transfer belt B, are constructed by respective rollers Rd, Rt, Rw, Rf, T2a, R1 to R5.

Also, the belt module BM in Exemplary Embodiment 1 is constructed by the intermediate transfer belt B, the belt supporting rollers Rd, Rt, Rt2, Rt3, Rw, Rf, T2a, R1 to R5, the primary transfer rollers T1g to T1k, the static electricity eliminating plate JB, and the like.

In FIG. 1, a secondary transfer unit Ut is arranged under the backup roller T2a. The secondary transfer unit Ut has a secondary transfer roller T2b as an example of the secondary transfer member. The secondary transfer roller T2b is arranged such that this roller may leave and contact the backup roller T2a via the intermediate transfer belt B. In FIG. 1 and FIG. 2, an area in which the secondary transfer roller T2b comes into contact with the intermediate transfer belt B with pressure constitutes the secondary transfer area Q4. Also, a contact roller T2c as an example of the contact power-feeding member contacts the backup roller T2a. The rollers T2a to T2c constitute a secondary transfer device T2 as an example of the final transfer device.

A secondary transfer voltage with same polarity as the toner charging polarity is applied to the contact roller T2c from the power supply circuit controlled by the controlling portion C at a predetermined timing.

In FIG. 1, the paper carry path SH2 is arranged under the belt module BM. The recording sheet S fed from the paper feed path SH1 of the paper feeding device U2 is carried to the paper carry path SH2 by a carry roller Ra as an example of the medium carrying member, and then is carried to the secondary transfer area Q4 through a medium guiding member SGr and a pre-transfer guiding member SG1 by a registration roller Rr as an example of the timing adjusting member in synchronism with the timing at which the toner image is carried to the secondary transfer area Q4.

In this case, the medium guiding member SGr together with the registration roller Rr is fixed/supported to the image forming apparatus main body U3.

The toner image on the intermediate transferring member B is transferred on the recording sheet S by the secondary transfer device T2 while such toner image passes through the secondary transfer area Q4. In the case of the full-color image, The toner images that are primarily transferred superposedly on the surface of the intermediate transferring member B are secondarily transferred at a time onto the recording sheet S.

The intermediate transferring member B after the secondary transfer is cleaned by a belt cleaner CLB as an example of the intermediate transferring member cleaner. The secondary transfer roller T2b and the belt cleaner CLB are supported such that this cleaner may leave and contact the intermediate transfer belt B.

The recording sheet S on which the toner images are secondarily transferred is carried to a fixing device F through a post-transfer guiding member SG2 and a paper carry belt BH as an example of the pre-fixing carrying member. The fixing device F has a heating roller Fh as an example of the heating/fixing member and a pressure roller Fp as an example of the pressurizing/fixing member. A fixing area Q5 is formed by an area in which the heating roller Fh and the pressure roller Fp are contacted with pressure.

The toner image on the recording sheet S is heated/fixed by the fixing device F while such toner image passes through the fixing area Q5. A carry switching member GT1 is provided on the downstream side of the fixing device F. The carry switching member GT1 switches selectively the recording sheet S, which is carried through the paper carry path SH2 and is heated/fixed in the fixing area Q5, to either the paper exhaust path SH3 side or the paper reverse path SH4 side of the paper processing device U4. The recording sheet S being carried to the paper exhaust path SH3 is carried to a paper carry path SH5 of the paper processing device U4.

A curl correcting unit U4a as an example of the curl correcting device is arranged in the middle of the paper carry path SH5. A switching gate G4 as an example of the carry switching member is arranged in the paper carry path SH5. The switching gate G4 carries the recording sheet S, which is carried from the paper exhaust path SH3 of the image forming apparatus main body U3, to either side of a first correcting member h1 and a second correcting member h2 in response to the direction of curve, i.e., curl. The curl of the recording sheet S carried to the first correcting member h1 or the second correcting member h2 is corrected at a time of passage. The recording sheet S whose curl is corrected is exhausted onto a paper exhaust tray TH1 as an example of the exhausting portion of the paper processing device U4 from an exhaust roller Rh as an example of the exhausting member in a state that an image fixing surface of the sheet is directed upward, i.e., a face-up state.

The recording sheet S being carried toward the paper reverse path SH4 side of the image forming apparatus main body U3 by the carry switching member GT1 is passed in the form of pushing away the carry restricting member constructed by the elastic thin film member, i.e., a miler gate GT2, and is carried to the paper reverse path SH4 of the image forming apparatus main body U3.

The paper circulate path SH6 and the paper reverse path SH7 are connected to the downstream end of the paper reverse path SH4 of the image forming apparatus main body U3. Also, a miler gate GT3 is arranged to their connection portion. The recording sheet S carried to the paper reverse path SH4 through the carry switching member GT1 is passed through the miler gate GT3, and is carried to a paper reverse path SH7 side of the paper processing device U4. In the case where the duplex printing should be done, the recording sheet S carried through the paper reverse path SH4 passes through the miler gate GT3 once, as it is, and is carried to the paper reverse path SH7, then is carried in the opposite direction, i.e., switched back while its carrying direction is restricted by the miler gate GT3, and then the recording sheet S switched back is carried to the paper circulate path SH6 side. The recording sheet S carried to the paper circulate path SH6 is passed through the paper feed path SH1, and is retransmitted to the secondary transfer area Q4.

In contrast, the recording sheet S carried through the paper reverse path SH4 is switched back after a rear end of the recording sheet S passes through the miler gate GT2 but before the rear end of the recording sheet S passes through the miler gate GT3, then the carrying direction of the recording sheet S is restricted by the miler gate GT2, and then the recording sheet S is carried to the paper carry path SH5 in a reversed state. The curl of the reversed recording sheet S is corrected by the curl correcting unit U4a, and then the recording sheet S may be exhausted onto the paper exhaust tray TH1 of the paper processing device U4 in a state that the image fixing surface of the recording sheet S is directed downward, i.e., a face-down state.

A paper carry path SH is constructed by the elements indicated by the symbols SH1 to SH7. Also, a medium carrying apparatus SU is constructed by the elements indicated by the symbols SH, Ra, Rr, Rh, SGr, SG1, SG2, BH, GT1 to GT3.

(Explanation of Method of Manufacturing Endless Belt Member)

A method of manufacturing the intermediate transferring member B as an example of the endless belt member, i.e., the endless belt, employed in the image forming apparatus U in Exemplary Embodiment 1 will be explained hereunder.

In Exemplary Embodiment 1, from respective aspects of strength, dimensional stability, thermal resistance, and the like, a polyimide resin PI or a polyamideimide resin PAI is employed as the film forming resin constituting the endless belt. As PI or PAI, various publicly known resins may be employed. In the case of PI, their precursors may also be applied.

The PI precursor solution may be obtained by causing tetracarboxylic dianhydride to react with a diamine component in a solvent. The types of respective components are not particularly limited. From a film strength, the film obtained by causing aromatic tetracarboxylic dianhydride to react with an aromatic diamine component is preferable.

As the typical example of aromatic tetracarboxylate, for example, pyromellitic dianhydride, 3,3′,4,4′-biphenyl tetracarboxylic dianhydride, 3,3′,4,4′-benzophenone tetracarboxylic dianhydride, 2,3,6,7-naphthalene tetracarboxylic dianhydride, 1,2,5,6-naphthalene tetracarboxylic dianhydride, 2,2-bis(3,4-dicarboxyphenyl)ether dianhydride, or their tetracarboxylate, or mixture of the tetracarboxylate series, and the like are listed.

Meanwhile, as the aromatic diamine component, paraphenylenediamine, metaphenylenediamine, 4,4′-diaminodiphenyl ether, 4,4′-diaminophenyl methane, benzidine, 3,3′-dimethoxybenzidine, 4,4′-diaminodiphenyl propane, 2,2-bis[4-(4-aminophenoxy)phenyl]propane, and the like are listed.

In contrast, PAI may be obtained by combining anhydride, e.g., trimellitic anhydride, ethylene glycol bisanhydrotrimellitate, propylene glycol bisanhydrotrimellitate, pyromellitic anhydride, benzophenone tetracarboxylic anhydride, pyromellitic anhydride, benzophenone tetracarboxylic anhydride, 3,3′,4,4′-biphenyl tetracarboxylic anhydride, or the like with the above diamine, and then applying the polycondensation reaction to them at an equimolecular amount. Since PAI has the amide group, such PAI easily dissolves in the solvent even after the imidation reaction proceeded. Therefore, PAI whose imidation reaction is completed perfectly is preferable.

As the solvent (solvent A) for them, an aprotic polar solvent such as N-methylpyrrolidone, N,N-dimethylacetamide, acetamide, or the like is employed. A concentration, a viscosity, etc. of the solution may be chosen adequately. In the solution suitable for the present invention, a concentration of the solid content is 10 to 40 mass % in both the inner and outer layers, and a viscosity is 1 to 100 Pa·S.

As the conductive particles that are dispersed into the resin solution, for example, the carbon-based substance such as carbon black, carbon fiber, carbon nanotube, graphite, or the like, the metal or alloy such as copper, silver, aluminum, or the like, the conductive metal oxide such as tin oxide, indium oxide, antimony oxide, or the like, the whisker such as potassium titanate, or the like, barium sulfate, titanium oxide, zinc oxide, and the like are listed. Out of them, the carbon black is particularly preferable from aspects of dispersion stability in the liquid, manifestation of the semi-conductivity, cost, and the like.

As the dispersing method, the publicly known method such as ball mill, sand mill (beads mill), jet mill (opposing collision type dispersing machine), or the like may be employed. As the dispersing auxiliary agent, surfactant, leveling agent, or the like may be added. It is preferable that a dispersing concentration of the conductive particles is set 10 to 40 parts, particularly 15 to 35 parts, with respect to a resin component 100 parts (parts by mass, ditto with the explanation given hereinafter).

Upon adjusting the resistance value, the method set forth in JP-A-2005-66838, for example, may be applied.

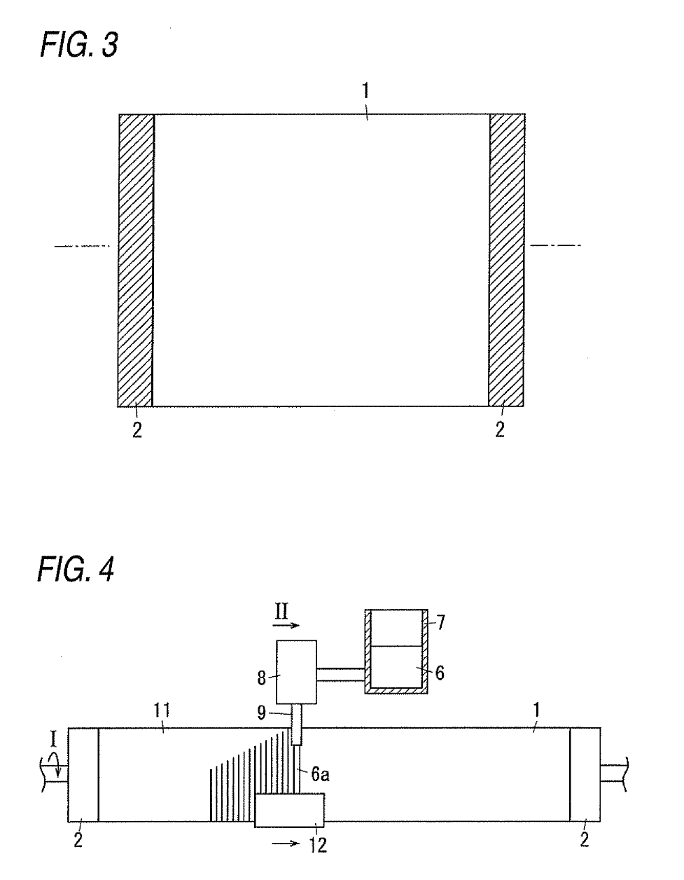

FIG. 3 is an overall explanatory view of a cylindrical core body of Exemplary Embodiment 1.

Next, a cylindrically shaped core body will be explained hereunder.

In FIG. 3, a metal such as aluminum, stainless steel, nickel, or the like may be employed as a cylindrically shaped core body 1. Because a surface of the aluminum is scratched easily, the stainless steel is particularly preferable. In this case, a thermal conductivity of stainless (SUS304) is 0.16 W/m·° C., and is about 1/12 of the aluminum and is small.

The core body 1 needs a length that is longer than the endless belt. In order to ensure a marginal area of an ineffective area caused at the end portion, it is desirable that the length of the cylindrical core body is longer than the length of the endless belt by about 10 to 40%.

A holding plate for reinforcing the core body 1 may be fitted to both ends of the core body 1 respectively. In fitting, various methods such as welding, screwing, etc. may be employed. Because the core body 1 may be fitted without play and the force may be applied uniformly, the welding is preferable. There are various welding methods such as gas welding, arc welding, plasma welding, electric resistance welding, TIG (Tungsten Inert Gas) welding, MIG (Metal Inert Gas) welding, MAG (Metal Active Gas) welding, and the like. The optimal method may be chosen depending on the type of metal.

In the case of the PI resin, such a disposition is shown that a gas is often generated at a time of heating/reacting the precursor. Because of the generated gas, a lantern-like inflation is easily caused partially in the PI resin film. When the resin film is thick such that a film thickness is in excess of 50 μm, such disposition becomes remarkable. As the gas that is generated at a time of heating/reacting, there are a volatile gas of the residual solvent and a vapor of moisture generated at a time of reacting.

In order to prevent the inflation, it is preferable that, for example, like the technology set forth in JP-A-2002-460239, the surface of the core body 1 is roughened to the extent of arithmetic mean roughness Ra of about 0.2 to 2 μm. This is because a gas such as volatile gas, vapor, or the like is hard to escape when the arithmetic mean roughness Ra is smaller than 0.2 μm whereas unevenness is formed on the surface of the manufactured endless belt when the arithmetic mean roughness Ra becomes larger than 2 μm. As the roughening method, there are the methods such as blasting, cutting, sandpaper grinding, and the like. Therefore, a gas produced from the PI resin may escape through minute clearances, which are formed between a cylindrical core body 1 and the PI resin film, to the outside, and as a result no inflation is produced.

In FIG. 3, before the film forming resin solution is applied on the surface of the core body 1, a masking member 2 as an example of the peeling assisting member may be wound and pasted to both end portions of the core body 1. As the masking member 2, a resin film such as polyester, polypropylene, or the like, or an adhesive tape using paper material such as crepe paper, flat paper, or the like as a base material may be employed. A width of the adhesive tape of about 10 to 25 mm is preferable. Acrylic adhesive material is preferable as the adhesive material on the adhesive tape. In particular, the adhesive material that is not left on the surface of the core body 1 when the adhesive tape is peeled off is preferable.

FIG. 4 is an explanatory view of a method of applying a film forming resin solution in Exemplary Embodiment 1 onto an outer surface.

A resin solution is applied onto the surface of the core body 1 by the appropriate coating method.

In FIG. 4, as the coating method, the coating method of adhering the resin solution onto the surface of the cylindrical core body 1 by dropping the resin solution while rotating the cylindrical core body 1 on the axis direction horizontally, i.e., the helical coating method, and the die type coating method are preferable. In particular, the helical coating method is preferable. That is, as shown in FIG. 4, a pump 8 as an example of the driving device for supply is connected to a vessel 7 in which a film forming resin solution 6 is contained, and then a nozzle 9 as an example of the coating portion is connected to the pump 8. The pump 8 discharges the resin solution 6 from the nozzle 9 in a predetermined amount. The nozzle 9 is supported movably in the axial direction of the cylindrical core body 1 in a state that the nozzle 9 is positioned close to an outer surface of the core body 1. When the film forming resin solution 6 is discharged by moving the nozzle 9 in the axis direction of the cylindrical core body in a state that the cylindrical core body 1 is being rotated at a predetermined rotation speed, a film forming resin solution 6a is applied helically onto the surface of the cylindrical core body 1, and a film 11 is formed. Then, a blade 12 as an example of the smoothing member is pushed against the coated film 11, and then the blade 12 is moved in the axial direction of the cylindrical core body 1 while rotating the cylindrical core body 1. As a result, a helical stripe formed on the surface is eliminated, and the seamless film 11 is formed.

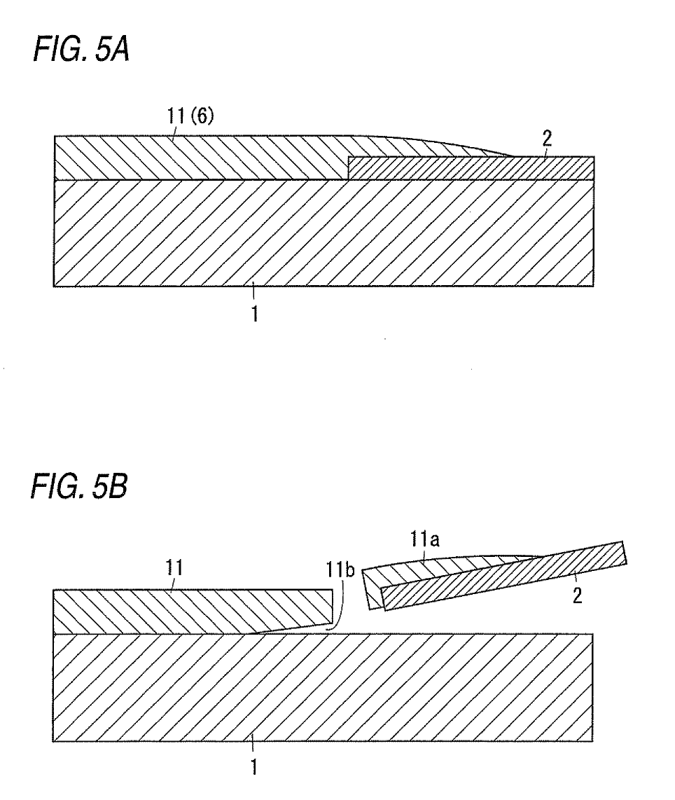

FIGS. 5A and 5B are pertinent enlarged explanatory views of a core body end portion, wherein FIG. 5A is an explanatory view of a state that the film forming resin solution is applied, and FIG. 5B is an explanatory view of a state that a masking member is released.

This coating method possesses such an advantage that a start position and an end position of the coating may be adjusted arbitrarily. When the masking member 2 is provided, it is desirable that, as shown in FIGS. 5A and 5B, the film forming resin solution 6 is applied to cover the end portion on the center side in the axial direction of the core body 1.

Then, the step of drying the film forming resin solution 6 is executed. Concretely, it is preferable that the film forming resin solution 6 is dried by heating the core body 1. A heating temperature 80° C. to 200° C. and a drying time of 10 min to 60 min are preferable as the heating conditions, and the heating temperature and the drying time may be shortened when a temperature is set higher. In the heating, it is effective to expose the film forming resin solution to a hot air. The heating temperature may be increased stepwise or may be increased at a constant rate. Since the coated film is ready to run down during the heating, the film forming resin solution 6 should be rotated slowly at about 5 to 60 rpm on the axis direction of the core body 1 in the horizontal direction. When the core body is rotated, such an advantage is obtained that temperature unevenness is hard to occur on the core body.

The film thickness is set within a range of 50 μm to 150 μm in the finished state to meet the need.

In a situation that the masking member 2 is provided, such masking member 2 is peeled off after the drying is completed. Accordingly, as shown in FIG. 5B, an end portion 11a of the dried film 11 is removed, and a clearance 11b is formed between the film 11 and the core body 11 at the end portion of the film 11. A length of the clearance 11b in the axial direction of the core body 1 is about 1 to 10 mm. This clearance 11b makes it easy to slip off the film 11 from the core body 1.

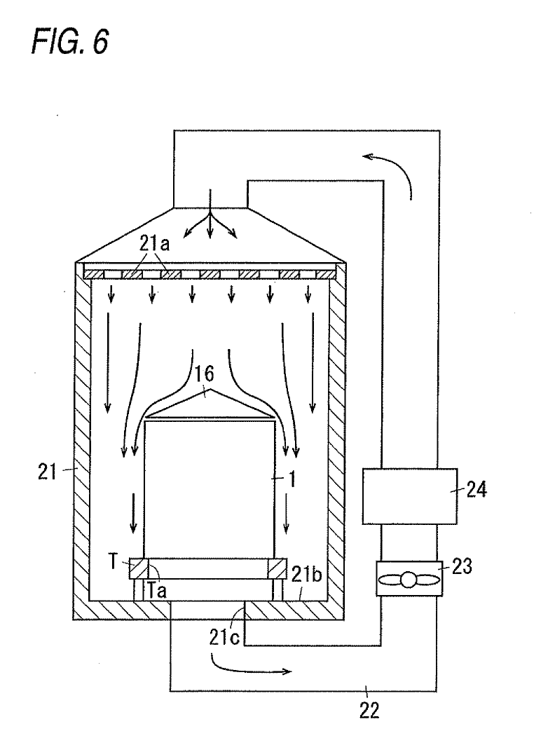

FIG. 6 is an explanatory view of a shielding member in Exemplary Embodiment 1.

Next, in Exemplary Embodiment 1, as shown in FIG. 6, a shielding member 16 is provided on the core body 1. The shielding member 16 is shaped like a circular cone. The shielding member 16 is supported at one end portion of the core body 1 in the axial direction such that a vertex of the circular cone is located on the outside of the core body 1 in the axial direction. In the shielding member 16, a diameter of a bottom surface of the circular cone is formed in the almost same size as an outer diameter of the cylindrical core body 1. Therefore, preferably the shielding member 16 does not largely change a flow of the wind fed from one end side of the core body 1, while preventing such a situation that a hot air fed from one end side is directly blown onto the core body 1. The circular cone, a frustum of circular cone having a shape that a vertex is cut from the circular cone, etc. are preferable.

In this case, the shielding member 16 may be supported to contact one end of the core body 1 in the axial direction, and may be supported via a clearance member, i.e., a spacer. When the spacer is provided, the worker may insert easily his or her fingers into a clearance being formed by the spacer, and thus may remove easily the shielding member 16 from the core body 1. The clearance being formed by the spacer may be set to about 1 cm, for example. In this case, the shielding member 16 may not be fitted to the core body 1 but may be provided on one end side of the core body 1, e.g., may be hung from or supported by a heating furnace 21 as described later, and others.

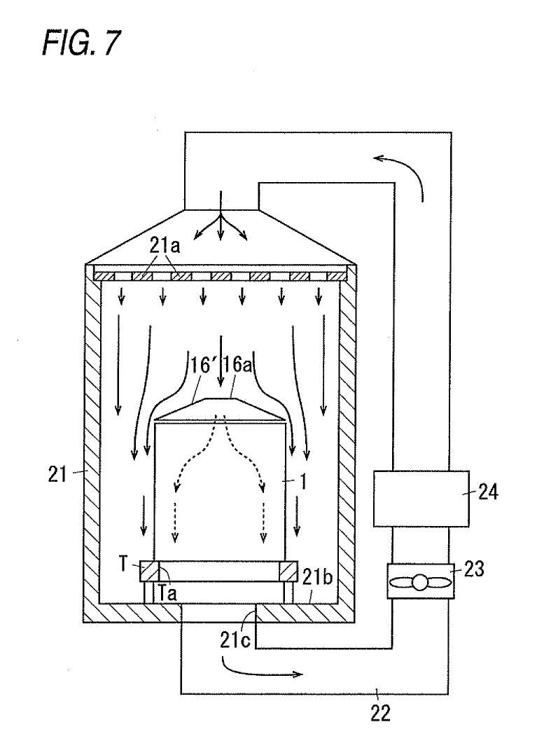

FIG. 7 is an explanatory view of a shielding member in Variation 1.

Also, a temperature rise of the core body 1 is made quicker when a hot air is also supplied to the inside of the core body 1. Therefore, as shown in FIG. 7, it is preferable that a vent port 16a is formed in a shielding member 16′ in a position that corresponds to a center of the core body 1. A diameter of the vent port 16a may be set arbitrarily. An amount of flow of the hot air is reduced when the diameter is too small, while a shielding effect is lessened when the diameter is too large. Therefore, the diameter that is about ¼ to ½ of the outer diameter of the core body 1 is preferable.

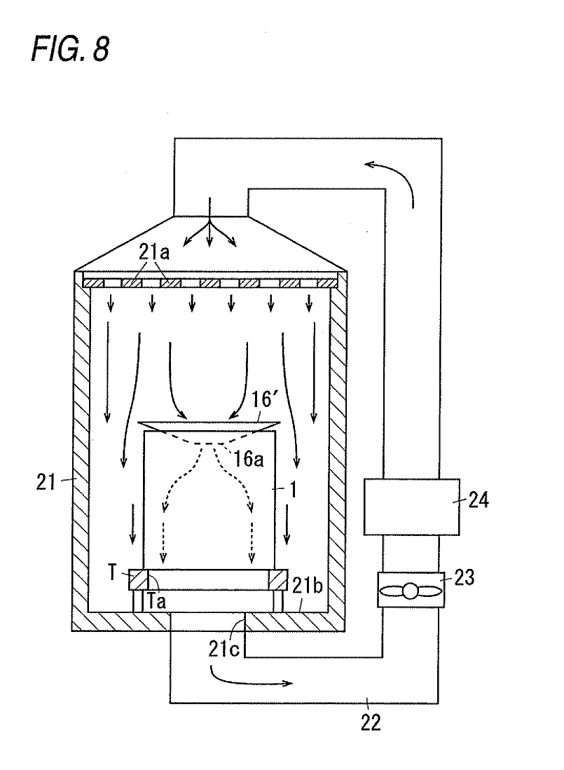

FIG. 8 is an explanatory view of a shielding member in Variation 2.

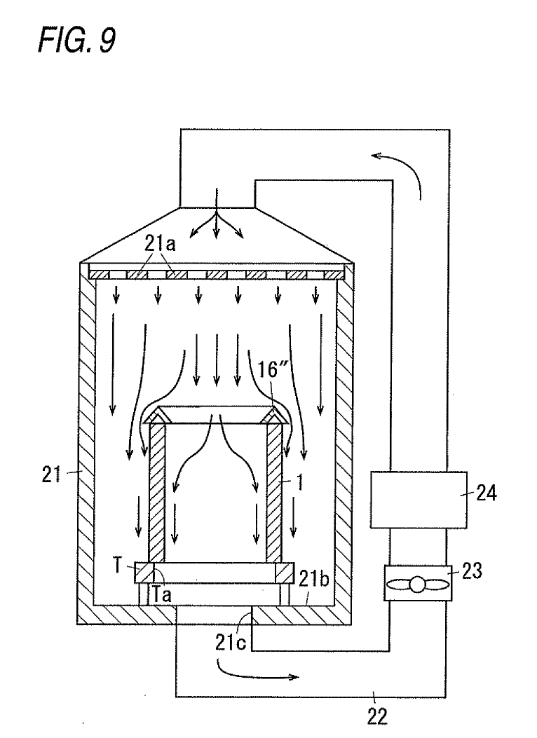

FIG. 9 is an explanatory view of a shielding member in Variation 3.

Also, as shown in FIG. 8, the shielding member 16′ may be supported in the opposite direction to that in FIG. 7 such that the wind fed from one end side of the core body 1 does not hit the end portion of the core body 1 but flows mainly through the inner side of the core body 1.

Also, in FIG. 9, a shielding member 16″ may be formed like an annular ring with which one end of the cylindrical core body 1 is fringed, i.e., a ring-like shape, whose section is formed like an umbrella to cover one end side of the core body 1.

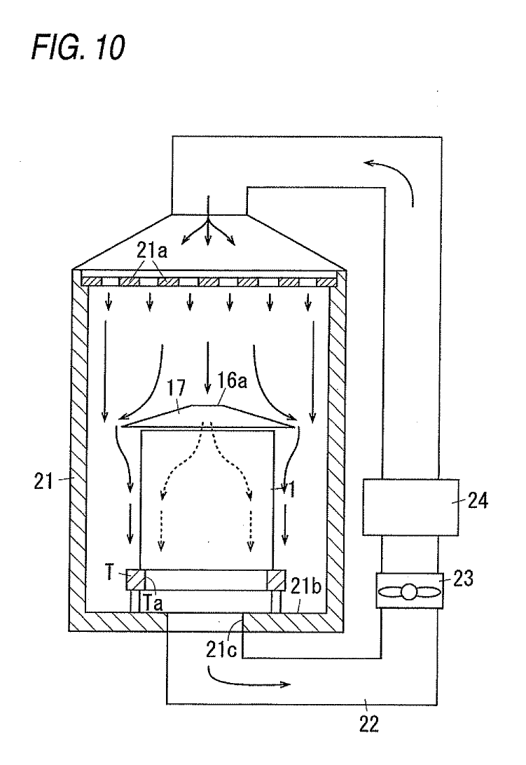

FIG. 10 is an explanatory view of a shielding member in Variation 4.

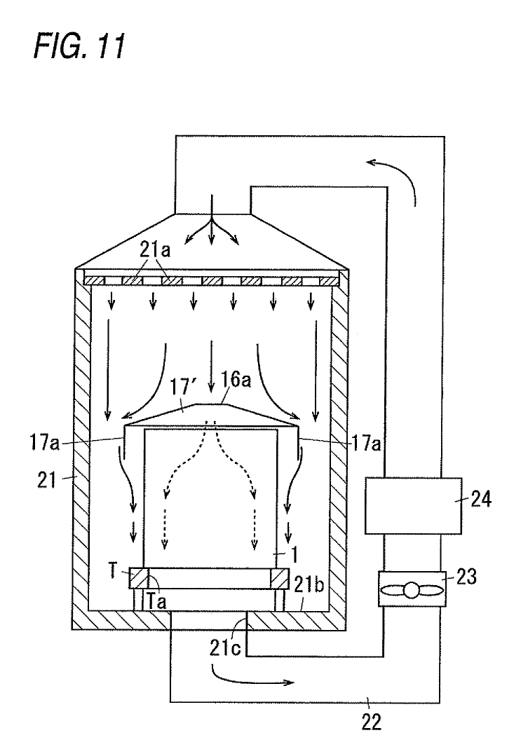

FIG. 11 is an explanatory view of a shielding member in Variation 5.

Also, an outer diameter of a shielding member 17 may be set in the almost same size as the outer diameter of the core body 1. In this case, as shown in FIG. 10, the outer diameter of the shielding member 17 may be set larger than the outer diameter of the core body 1.

Further, as shown in FIG. 11, an annular enclosure 17a may be provided to prevent surely such a situation that a temperature of the upper portion of the core body 1 is increased. This annular enclosure 17a is disposed at the outer periphery of a bottom surface of a circular cone of a shielding member 17′ a diameter of which is larger than the outer diameter of the core body 1, at a distance from the core body 1.

Then, in the heating step of forming the endless belt B by heating the film 11 after dried, the core body 1 to which the shielding member 16, 16′, 16″, 17, 17′, or the like is provided is put into the heating furnace 21, and is heated. A heating temperature is set preferably to about 250° C. to 450° C., more preferably 300° C. to 350° C. The imidation reaction is induced by heating the film 11 of the PI precursor for 20 min to 60 min at the above heating temperature, and the PI resin film is formed. It is preferable that, in the heating reaction, the heating is applied by increasing gradually the temperature stepwise or at a constant rate before the temperature reaches the final heating temperature.

In case the film forming resin solution 6 is formed of PAI, the film may be formed only by drying the solvent.

In the above heating step, the core body 1 is put into the heating furnace 21. Since the heating temperature is high, it is difficult to rotate the core body 1 unlike the drying step. Normally, the core body 1 is put upright into the heating furnace 21, i.e., in a state that the axial direction of the core body 1 is set along a gravity direction. As the heating furnace 21, in order to eliminate temperature unevenness in the inside as much as possible, the furnace having such a structure that a hot air blows out from the top side, i.e., one end side of the core body 1 being set upright is preferable.

In FIG. 6, in the heating furnace 21 in Exemplary Embodiment 1, a supporting table T for supporting the core body 1 is provided in the inside of the heating furnace 21. In this case, a port portion Ta through which a gas may pass is formed in the center portion of the supporting table T. An upper end surface 21a of the heating furnace 21 serves as a blowing plane that blows a gas downward from its whole surface. An inlet port 21c for sucking a gas from the inside of the heating furnace 21 is formed in a bottom surface 21b of the heating furnace 21. A duct 22 as an example of the ventilating path is connected to the inlet port 21c, and also the duct 22 is connected to the upper end surface 21a. A fan 23 as an example of the blowing part is provided in the course of the duct 22, and transfers a gas from the inlet port 21c to the upper end surface 21a. A heater 24 as an example of the heating part is arranged on the downstream side in the blowing direction of the fan 23, and increases a temperature of the gas in the duct 22. A plate member in which a large number of holes are formed, i.e., a punching metal, is provided to the upper end surface 21a, and a gas fed from the duct 22 is uniformly sprayed downward from the upper end surface 21a.

In this case, preferably an air velocity in the heating furnace 21 is set to about 1.0 to 5.0 m/s from the upper side to the lower side. Also, it is preferable that a variation in air velocity is suppressed as small as possible throughout the heating furnace 21. In this case, an air velocity is measured by an anemometer (e.g., NL type manufactured by Tornic Co., Ltd.).

After the heating is completed, the core body 1 is taken out from the heating furnace 21 and then the formed film 11 is slipped off from the core body 1, so that the endless belt B may be obtained. At that time, when the adhesion between the film 11 and the core body 1 is released by blowing a pressurized air into the clearance 11b (see FIG. 5B) at the end portion of the film 11, the formed film 11 is easily slipped off.

Since the defects such as wrinkles, unevenness of the film thickness, etc. are present at the end portion of the resultant film, the endless belt B is finished by cutting the unnecessary portion. If necessary, the drilling process, the rib fitting process, or the like is applied to the endless belt B.

Therefore, in the method of manufacturing the endless belt B in Exemplary Embodiment 1, the shielding member 16, 16′, 16″, 17, 17′, or the like for shielding a hot air to prevent such a situation that a hot air is blown directly to one end side of the core body 1 is provided to one end side of the core body 1. Thus, such a situation is suppressed that one end side of the core body 1 reaches first a high temperature. That is, temperature unevenness in the core body 1 in the axial direction is reduced. Therefore, unevenness of the electric resistance of the manufactured endless belt B is reduced, and the electric resistance is made uniform.

In other words, in the heating step, shrinkage of a resin is caused by the imidation reaction, the volatilization of the solvent, or the like in the heating. The shrinkage is increased when a temperature rises higher. At this time, because a degree of shrinkage is different depending on a temperature, in some cases a degree of contact between the conductive particles in the shrunk film becomes different when the interval between the conductive particles is narrowed or the conductive particles come into contact with each other. When a degree of contact is different, unevenness of the electric resistance, especially a surface resistivity, is caused in the resultant intermediate transfer belt B. The image formed in the portion whose surface resistivity is low is scattered to the surrounding portion whose surface resistivity is high, while the toner is hard to be transferred on the portion whose surface resistivity is high and a density is lowered. Therefore, such a condition is demanded that a temperature of the core body 1 is uniform over a whole surface.

In particular, in the conventional endless belt, a peripheral length of the endless belt is short and a thickness is about 2 to 3 mm at most with respect to the peripheral length of the employed cylindrical core body 1, so that sufficient strength of the core body 1 is obtained. In this case, even though a heat capacity of the core body 1 is not so large and the shielding member 16, 16′, 16″, 17, 17′, or the like is not provided, unevenness of the electric resistance is not so conspicuous. In this structure, it is needless to say that preferably the shielding member 16, 16′, 16″, 17, 17′, or the like is provided.

In contrast, in Exemplary Embodiment 1, the intermediate transfer belt B corresponding to six colors has the long peripheral length rather than the conventional one. When a thickness of the cylindrical core body 1 is set similarly to conventional one, the core body 1 is short of strength and rigidity and may not holds its own cylindrical shape. Hence, a thickness of the core body 1 must be made thick, and accordingly a heat capacity of the core body 1 is increased. When the shielding member 16, 16′, 16″, 17, 17′, or the like is not provided, temperature unevenness becomes conspicuous, and as a result temperature unevenness of the intermediate transfer belt B becomes an issue.

Accordingly, in Exemplary Embodiment 1, temperature unevenness is reduced in the core body 1 to which the shielding member 16, 16′, 16″, 17, 17′, or the like is not provided. Also, unevenness of the electric resistance of the manufactured intermediate transfer belt B is reduced. As a result, in a situation that the intermediate transfer belt B is used in the image forming apparatus, a reduction in picture quality such as unevenness of a density in a halftone image, or the like is suppressed.

Next, an experiment is made to confirm the advantage of Exemplary Embodiment 1.

### Experimental Example 1

In Experimental Example 1, as the cylindrical portion of the cylindrical intermediate transfer belt B, a cylinder made of SUS304 and having an outer diameter of 600 mm, a thickness of 8 mm, and a length of 1 mm is prepared. In Experimental Example 1, a circular plate, which has a thickness of 10 mm and has an outer diameter that may be fitted into the cylinder and in which four vent ports of 150 mm diameter are provided, is formed of SUS304 as the holding plate, and then the core body 1 is constructed by fitting/welding the circular plate onto the cylinder.

The surface is roughened to Ra0.4 μm by the blasting process using the spherical alumina particles.

The silicon-based release agent (product name: “Sepacoat” (registered trademark) manufactured by Shin-Etsu Chemical Co., Ltd.) is applied onto the surface of the cylindrical core body 1 by the spray, and the resultant structure is held in the heating furnace at 300° C. for one hour and the burning process is applied.

As shown in above FIG. 3, the masking member 2 (product name: “Scotch Tape #232” manufactured by Sumitomo 3M Ltd., formed of the crepe paper base material and the acrylic adhesive, and having a width of 24 mm) is pasted by one turn over the whole circumference on both ends of the core body 1 respectively.

In Experimental Example 1, the carbon black (product name: “Special Black 4” manufactured by Degussa Hywuls Corporation) is mixed with the PI precursor solution (product name: “U varnish” manufactured by Ube Industries, Ltd., a concentration of the solid content is 18%, and the solvent is N-methylpyrrolidone) 100 wt % at a solid content mass ratio of 27%, and then the mixed solution is dispersed by the opposing collision type dispersing machine (“Geanus PY” manufactured by Geanus Co., Ltd). Thus, the coating liquid whose viscosity at 25° C. is about 42 Pa·s is obtained.

The PI precursor coating film is formed of the coating liquid by the helical coating machine shown in FIG. 4.

In the coating, the mohno pump 8 is connected to the vessel 7 in which the PI precursor solution 6 is contained by 10 [L], then the solution 6 is discharged a rate of 60 ml/min from the nozzle 9, then the discharged solution 6 is adhered onto the core body 1 while rotating the cylindrical core body 1 at 20 rpm in the rotating direction I, and then the blade 12 is pushed against the surface and is moved in the core body axial direction II at a velocity of 50 mm/min.

The blade 12 used as the smoothing member in Experimental Example 1 is formed by processing a stainless plate of 0.2 mm thickness to have a width of 20 mm and a length of 50 mm.

A coating width is set between a position distant from one end portion of the cylindrical core body 1 by 10 mm and a position distant from the other end portion by 10 mm.

A helical stripe formed on the surface of the coating film disappears when the rotation is continued for 5 min as it is after the coating is completed. Accordingly, the layer whose film thickness is about 500 μm is formed. This thickness corresponds to the finished film thickness of 80 μm.

Then, the core body is put into the drying furnace at 190° C. while rotating at 10 rpm, and then dried for 20 min. Then, the core body is taken out, and the masking member 2 is peeled off by hand. At that time, the end portion of the dried film 11 is held down with one hand to prevent such a state that the film 11 is torn. After this step, the clearance 11b whose width is 5 to 8 mm is formed at the end portion of the film 11.

Then, the cylindrical core body 1 is brought down from the turn table (not shown) of the drying furnace, and then the shielding member 16′ in Variation 1 is put on the core body 1 while setting vertically the axial direction. The shielding member 16′ has an outer diameter 600 mm of the bottom surface and a height 120 mm, and the vent port 16a of 150 mm diameter is formed in the center. The shielding member 16′ is manufactured by processing a SUS304 plate of 1 mm thickness.

Then, the core body 1 equipped with the shielding member 16′ is put into the heating furnace 21, and then is heated for 30 min at 200° C. and for 30 min at 300° C. Thus, the drying of the residual solvent and the imidation reaction of the PI resin are performed simultaneously.

In Experimental Example 1, the heating furnace 21 has a width 1.8 m, a height 2.4 m, and a depth 1.5 m as inner dimensions, and the heating furnace 21 is constructed such that a heating air is blown down from the top and is sucked into the bottom. When the air velocity in the heating furnace 21 is measured by the anemometer (NL type manufactured by Tornic Co., Ltd.) in a state that the core body 1 is not equipped, the air velocity is 1.4 m/s to 1.8 m/s in respective portions of the heating furnace 21, and is 1.6 m/s on average.

After the core body 1 is cooled to a room temperature, the film 11 made of a resin is slipped off from the core body 1 by spraying a pressurized air into the clearance 11b between the core body 1 and the film 11. Thus, the endless belt is obtained. Then, the center of the endless belt is cut and the unnecessary portion is cut off from both ends, and thus two intermediate transfer belts B of 360 mm width are obtained. When the film thickness is measured at 5 locations in the axial direction and 10 locations in the circumference direction, i.e., 50 locations in total, by the dial gauge, the average film thickness is 80 μm.

### Comparative Example 1

In Comparative Example 1, except that the shielding member 16′ is not put on the core body 1 when the core body 1 is loaded into the heating furnace 21 in Experimental Example 1, the endless belt is manufactured similarly to Experimental Example 1.

In Experimental Example 1 and Comparative Example 1, a surface resistivity of the endless belt B and a reached temperature of the core body in the heating furnace are measured.

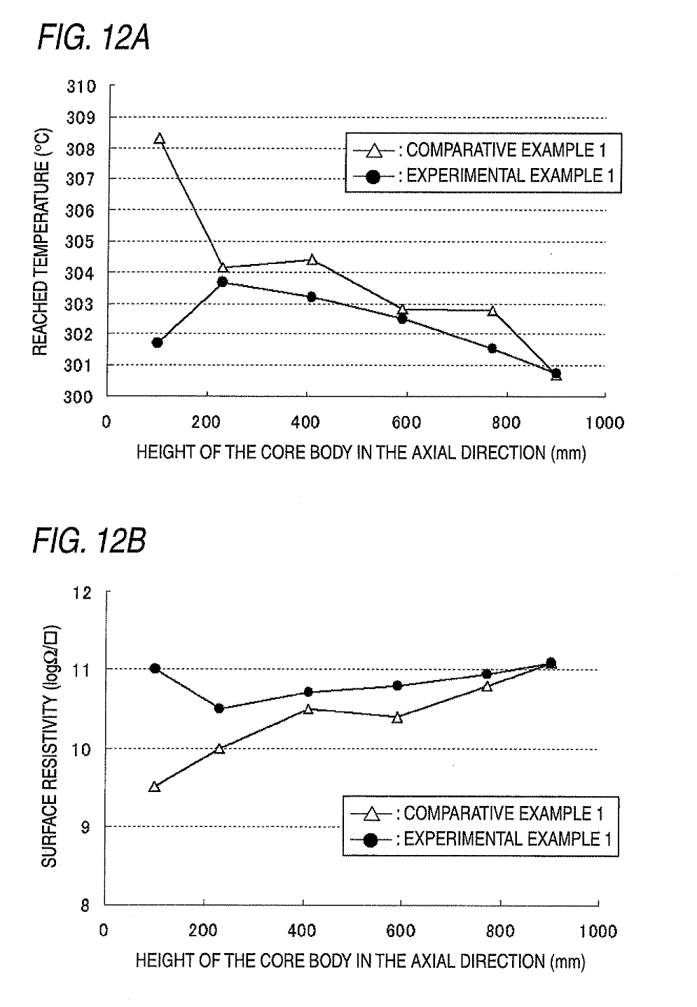

FIGS. 12A and 12B are explanatory views of experimental results in Experimental Example 1 and Comparative Example 1, wherein FIG. 12A is a graph in which a height of a core body in the axial direction is plotted on an abscissa and a reached temperature is plotted on an ordinate, and FIG. 12B is a graph in which a height of a core body in the axial direction is plotted on an abscissa and a surface resistivity is plotted on an ordinate.

(Measurement of Reached Temperature)

A surface resistance of the endless belt B has a correlation with a reached temperature of the core body 1 at a time of heating, and the resistance decreases lower as a temperature rises higher. In order to reduce in-plane unevenness of the electric resistance of the endless belt, the reached temperature must be made uniform. Therefore, a temperature of the core body at a time of heating is examined in Experimental Example 1.

In the measurement, a temperature is measured at four points separated by 90° in the circumferential direction at a height of 100 mm, 200 mm, 400 mm, 600 mm, 800 mm, 900 mm from the top end of the core body 1 in the axial direction of the core body 1 respectively, and then an average value is calculated. The experimental results are shown in FIG. 12A.

In FIG. 12A, in Comparative Example 1 indicated by A, a temperature at the top portion of the core body 1 is very high and a temperature is lowered gradually downwardly. This is because a hot air directly blows against the top portion of the core body 1 to raise a temperature. In contrast, in FIG. 12A, in Experimental Example 1 indicated by , the shielding member 16′ is provided to the top portion of the core body 1 such that a hot air does not directly blow against the top portion of the core body 1. Therefore, a temperature at the top portion of the core body 1 is decreased, and also whole temperature unevenness is made small.

(Measurement of Resistivity)

Then, a surface resistivity of the endless belt is measured in positions that correspond to the temperature measuring positions of the core body 1 respectively.

A “surface resistivity” denotes a numerical value that is derived by dividing a potential gradient, which is taken in parallel with an electric current that flows through a surface of a test piece, by an electric current per unit width of a surface. This surface resistivity is equal to a surface resistance between two electrodes that are set in opposing sides of a square each side of which is 1 cm. The unit of surface resistivity is Ω formally, but the unit of Ω/□ is used so as to distinguish the surface resistivity from the simple resistance.

The measurement is made by applying a voltage to the ring electrode based on JIS K6911 (1995), while using a digital ultra-high resistance/micro ammeter (R8340A manufactured by Advantest Corporation), and a UR probe MCP-HTP12 having the double ring electrode structure whose connection portion is converted for the special purpose and a registration table UFLMCP-ST03 (both manufactured by DIA Instruments Corporation).

In the measurement, a test piece is placed on the registration table, then the double electrodes of the UR probe is put on the test piece to contact a measured surface, and then a weight whose mass is 2.0±0.1 kg (19.6±1.0 N) is fitted to the top portion of the UR probe to apply a predetermined load to the test piece.

As the measuring conditions, a voltage apply time is set to 10 sec and an applied voltage is set to 100 V. At this time, when a value of the digital ultra-high resistance/micro ammeter R8340A is read as R and a correction factor of the surface resistivity of the UR probe MCP-HTP12 is given as RCF(S), the “Resistivity Meter Series” catalogue of DIA Instruments Corporation shows RCF(S)=10.0, and thus a surface resistivity ρs is given by following Equation (1).

ρ(Ω/□)=R×RCF(S)=R×10.0

The measured results of the surface resistivity are shown in FIG. 12B.

In the results of Experimental Example 1, as indicated by in FIG. 12B, an average is 10.84 [log Ω/□] and a variation given as difference between a minimum value and a maximum value is 0.6. In contrast, in Comparative Example 1, as indicated by in FIG. 12B, an average is 10.38 [log Ω/□] and a variation is 1.6. In this manner, in Experimental Example 1, it is appreciated that a variation of a surface resistivity is greatly improved.

In this case, in the surface resistivity needed for the intermediate transfer belt B, an average of 10.8 [log Ω/□] and a variation within 1.0 are preferable by way of example.

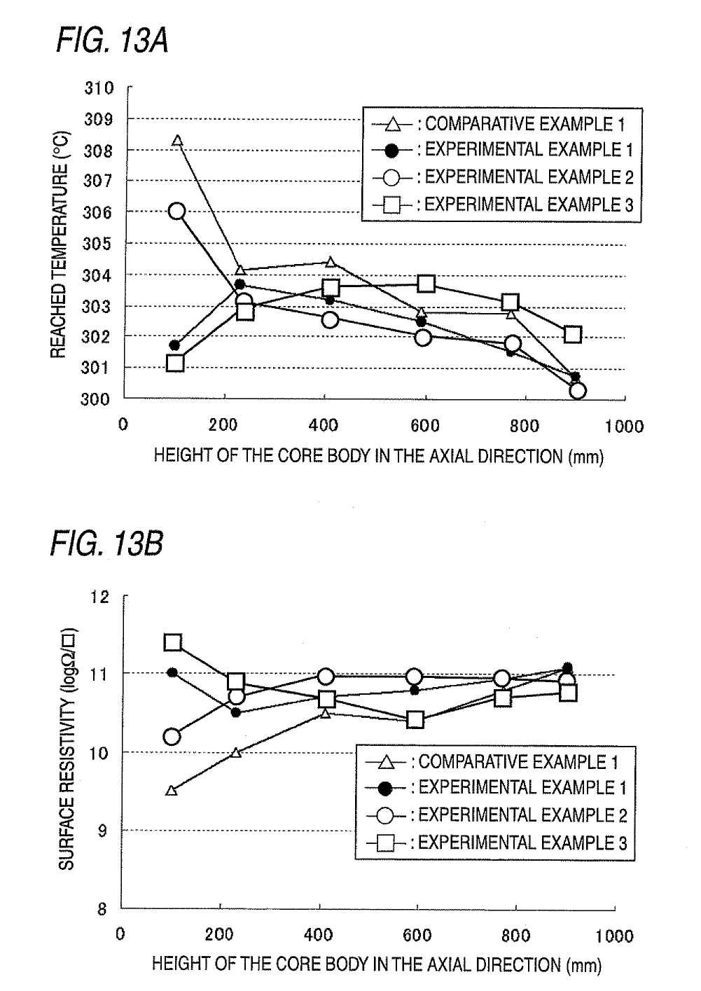

FIGS. 13A and 13B are explanatory views of experimental results in Experimental Examples 1 to 3 and Comparative Example 1, wherein FIG. 13A is a graph in which a height of a core body in the axial direction is plotted on an abscissa and a reached temperature is plotted on an ordinate, and FIG. 13B is a graph in which a height of a core body in the axial direction is plotted on an abscissa and a surface resistivity is plotted on an ordinate.

### Experimental Example 2

In Experimental Example 2, except that, as the shielding member 16 being put on the core body 1 when the core body 1 is loaded into the heating furnace 21, an outer diameter of 600 mm and a height of 160 mm are set and also the vent port is not formed in the center as shown in FIG. 6, the endless belt is manufactured similarly to Experimental Example 1. In Experimental Example 2, a reached temperature of the core body 1 and a surface resistivity of the endless belt are measured like Experimental Example 1. The experimental results are shown in FIGS. 13A and 13B.

In Experimental Example 2 indicated by O in FIGS. 13A and 13B, an average of the surface resistivity is 10.90 [log Ω/□] and a variation is 0.8. Also, the reached temperature is lowered substantially by about 0.5° C. in all positions in contrast to Experimental Example 1.

### Experimental Example 3

In Experimental Example 3, except that the shielding member 16′ being put on the core body 1 when the core body 1 is loaded into the heating furnace 21 is turned upside down as shown in FIG. 8, the endless belt is manufactured similarly to Experimental Example 1. In Experimental Example 3, a reached temperature of the core body 1 and a surface resistivity of the endless belt are measured like Experimental Example 1. The experimental results are shown in FIGS. 13A and 13B.

In Experimental Example 3 indicated by □ in FIGS. 13A and 13B, an average of the surface resistivity is 10.75 [log Ω/□] and a variation is 0.8.

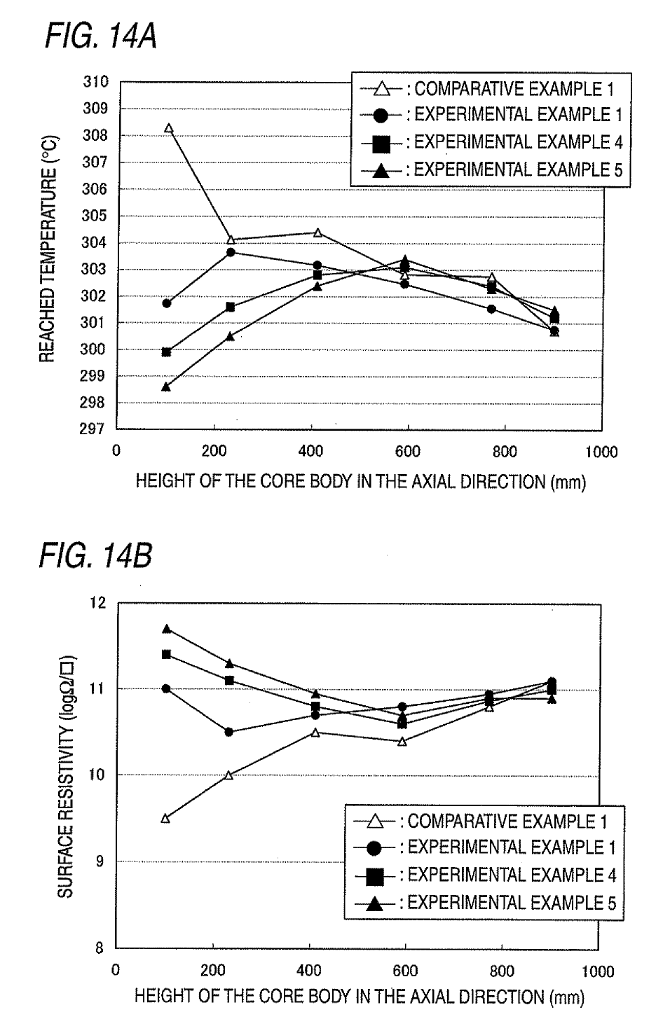

FIGS. 14A and 14B are explanatory views of experimental results in Experimental Examples 1, 4, 5 and Comparative Example 1, wherein FIG. 14A is a graph in which a height of a core body in the axial direction is plotted on an abscissa and a reached temperature is plotted on an ordinate, and FIG. 14B is a graph in which a height of a core body in the axial direction is plotted on an abscissa and a surface resistivity is plotted on an ordinate.

### Experimental Example 4

In Experimental Example 4, except that, as the shielding member 17 being put on the core body 1 when the core body 1 is loaded into the heating furnace 21, the shielding member 17 which has an outer diameter of 700 mm and a height of 140 mm and in which the vent port of 175 mm diameter is formed in the center as shown in FIG. 10 is employed, the endless belt is manufactured similarly to Experimental Example 1. In Experimental Example 4, a reached temperature of the core body 1 and a surface resistivity of the endless belt are measured like Experimental Example 1. The experimental results are shown in FIGS. 14A and 148.

In Experimental Example 4 indicated by ▪ in FIGS. 14A and 14B, an average of the surface resistivity is 10.96 [log Ω/□] and a variation is 0.8.

### Experimental Example 5

In Experimental Example 5, except that, when the core body 1 is loaded into the heating furnace 21, as shown in FIG. 11, the shielding member 17′ having the annular enclosure 17a whose length in the axial direction of the core body 1 is 150 mm is employed and also the shielding member 17 which has an outer diameter of 700 mm and a height of 240 mm and in which the vent port of 175 mm diameter is formed in the center is employed, the endless belt is manufactured similarly to Experimental Example 1. In Experimental Example 5, a reached temperature of the core body 1 and a surface resistivity of the endless belt are measured like Experimental Example 1. The experimental results are shown in FIGS. 14A and 14B.

In Experimental Example 5 indicated by ▴ in FIGS. 14A and 14B, an average of the surface resistivity is 11.08 [log Ω/□] and a variation is 1.0.

With the above, like Exemplary Embodiment 1, when a hot air is shielded by providing the shielding member 16, 16′, 16″, 17, 17′, or the like to prevent such a situation that a hot air blows directly against one end of the core body 1, a variation of the surface resistivity is suppressed.

(Evaluation of Transferred Image)

The endless belt obtained in this manner is fitted to the image forming apparatus (DocuCentreColor 400CP is modified into 4800 DPI) manufactured by Fuji Xerox Co., Ltd. as the intermediate transfer belt, and the evaluation of picture quality is done. As the evaluation items of picture quality, density unevenness in the 0.2 G halftone image is measured by the X-Rite densitometer (manufactured by X-Rite Corporation).

As a result, in all the endless belts in Experimental Examples 1 to 5, an amount of variation is suppressed less than 5%. In contrast, in the endless belt in Comparative Example, an amount of variation is suppressed less than 15%.

(Variation)

Exemplary Embodiment and Variations are described in detail as above. The present invention is not limited to above Exemplary Embodiment and Variations. Further, various variations may be applied within a scope of a gist of the present invention. Variations (H01) to (H06) of the present invention are illustrated hereunder.

(H01) In above Exemplary Embodiment, the image forming apparatus U is constructed by the so-called printer, but the present invention is not limited to this apparatus. The image forming apparatus U may be constructed by a copying machine, a facsimile machine, a multifunction machine equipped with plural or all function of them, or the like, for example.

(H02) In above Exemplary Embodiment, the printer U is not limited to the configuration in which six color tones are employed. The printer U may be applied to either the image forming apparatus in which seven colors or more or five colors or less are employed or the monochromatic image forming apparatus, for example.

(H03) In above Exemplary Embodiment, the intermediate transfer belt B is illustrated as the endless belt member, but the present invention is not limited to this mode. The present invention may be applied to the endless belt member such as the photosensitive belt, the charging belt, the recording medium carrying belt, or the like, for example.

(H04) In above Exemplary Embodiment, concrete cited material, numerical values, and shapes may be changed arbitrarily according to the design, the specification, and the like.

(H05) In above Exemplary Embodiment, the shielding member that is shaped into the circular cone and the frustum of circular cone are respectively illustrated. The shielding member may be shaped into a polygonal cone such as triangular pyramid, quadrangular pyramid, or the like or frustum of these polygonal cones, for example.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A method of manufacturing an endless belt member, the method comprising at least:
applying a film forming resin solution onto a surface of a cylindrical core body;
drying the film forming resin solution applied on the core body while rotating the core body around an axial direction of the core body;
providing a shielding member to one end side of the core body in the axial direction, the shielding member shielding a wind fed from the one end side; and
manufacturing an endless belt member on which the film forming resin is solidified, by putting the core body to which the shielding member is provided into a heating furnace equipped with a blowing part that blows a hot air from the one end side, and heating the core body.

2. The method of manufacturing an endless belt member according to claim 1,
wherein the shielding member is conical in shape.

3. The method of manufacturing an endless belt member according to claim 1,
wherein an outer diameter of the shielding member is larger than an outer diameter of the core body.

4. The method of manufacturing an endless belt member according to claim 3,
wherein an annular enclosure is disposed at an outer periphery of a bottom surface of the shielding member at a distance from the core body, and
a diameter of the annular enclosure is larger than the outer diameter of the core body.

5. The method of manufacturing an endless belt member according to claim 1,
wherein a vent port that guides a wind to a cylindrical shaped inner surface side of the core body is formed in a part of the shielding member.

6. The method of manufacturing an endless belt member according to claim 5,
wherein a diameter of the vent port is ¼ to ½ of the outer diameter of the core body.

7. The method of manufacturing an endless belt member according to claim 5,
wherein the shielding member has a frustum shape of circular cone or an annular shape.

8. The method of manufacturing an endless belt member according to claim 1,
wherein the shielding member is supported to contact the one end side of the core body in the axial direction.

9. The method of manufacturing an endless belt member according to claim 1,
wherein the shielding member is supported to the one end side of the core body in the axial direction via a clearance member.

10. The method of manufacturing an endless belt member according to claim 9,
wherein a clearance between the shielding member and the one end side of the core body in the axial direction, which is formed by the clearance member, is about 1 cm.

11. The method of manufacturing an endless belt member according to claim 1,
wherein the shielding member is hung from or supported by the heating furnace so as to be provided to the one end side of the core body in the axial direction.

12. An endless belt member manufactured by the method of manufacturing a endless belt member according to claim 1.

13. An image forming apparatus, comprising:
a visible image forming apparatus having an image holding body, a latent image forming device that forms a latent image on a surface of the image holding body, and a developing unit that develops the latent image on the surface of the image holding body into a visible image;
an intermediate transfer member arranged to oppose to the image holding body and formed of the endless belt member according to claim 12;
a primary transfer device that transfers the visible image formed on the surface of the image holding body onto a surface of the intermediate transferring member;
a final transfer device that transfers the visible image formed on the surface of the intermediate transferring member on a medium; and
a fixing device that fixes the visible image transferred onto the medium.
